(19) United States
(12) Patent Application Publication
(10) Pub. No.: US 2004/0249805 A1
(43) Pub. Date: Dec. 9, 2004

(54) Method of sorting and indexing of complex data

(76) Inventor: Alexey Chuvilskiy, North York (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/858,069

(22) Filed: Jun. 2, 2004

Related U.S. Application Data
(60) Provisional application No. 60/475,474, filed on Jun. 4, 2003.

(51) Int. Cl. G06F 7/00

(52) U.S. Cl. 707/3

(57) ABSTRACT

A new method of sorting and indexing data using a new data structure is introduced. The new data structure is a version of a binary search tree that provides indexing operations on complex data structures. The indexing is achieved by storing additional information on comparison of the keys in every node of a binary search tree. In most cases this information helps avoid repeated comparisons of the initial elements or completely excludes comparison of keys. The new data structure permits rotations and deleting of its nodes using methods of restoring the structure before, during or after the operations

### FIELD OF THE INVENTION

This invention relates to a computer implementable method of sorting and indexing of complex data.

### BACKGROUND OF THE INVENTION

The known balanced binary search trees such as AVL tree or red-black tree provide fast sorting and search for simple data with indivisible operation of comparison. However, for more complex data such as character strings, the efficiency of direct application of binary search tree is lowered, as it is necessary to duplicate comparisons of all initial characters up to the position of the difference of the keys on all levels of the tree.

### SUMMARY OF THE INVENTION

The new method of sorting and indexing complex data is based on the properties of the new data structure, called Position Tree, that gives the possibility to use benefits of binary search trees and balanced binary search trees while working with complex data types.

Position Tree stores results of comparison of complex data in the nodes of a binary tree. The data structure helps avoiding repeated comparisons and allows standard rotations and deletion of nodes with minor modifications of the algorithms.

Simplicity and unification of Position Tree make it useful in application programs for fast sorting and search of strings and many other complex types of data including database tables.

### BRIEF DESCRIPTION OF THE DRAWINGS

The present invention will now be described, by way of example only, with reference to the following drawings:

FIG. 1. A Position Tree node diagram.

FIG. 2. Example of Pascal definition of Position Tree node.

FIG. 3. Example of Pascal implementation of P function for C-strings.

FIG. 4. Diagram of insertion algorithm.

FIG. 5a-5d. Insertion of nodes into Position Tree.

FIG. 6. The parent node is an Ancestor Node.

FIG. 7. The parent node is not an Ancestor Node.

FIG. 8. Diagram of search algorithm.

FIG. 9. Example of Pascal implementation of helper function that can be used for navigation in Position Tree.

FIG. 10. Example of Pascal implementation of the search algorithm.

FIG. 11a, 11b. Examples of using of the definition of Twin Node.

FIG. 12. Example of Pascal implementation of the Twin Node search and update algorithm.

FIG. 13. Example of Pascal implementation of the exchanging Positions algorithm.

FIG. 14a, 14b. Example of Single Rotation Left procedure in Position Tree.

FIG. 15a, 15b. Example of Single Rotation Left with exchanging Position values.

FIG. 16a, 16b. Example of Single Rotation Left with updating of Twin Node.

FIG. 17a, 17b. Diagrams of single rotations of nodes in Position Tree.

FIG. 18. Example of Pascal implementation of the single rotation algorithms.

FIG. 19. Diagram of selection of replacement node for the deleting one.

FIG. 20. Example of Pascal implementation of calculating the Position values for delete node algorithm.

FIG. 21. Example of Pascal implementation of the selecting Replacement Node algorithm.

FIG. 22a, 22b. Diagrams of updating nodes during deletion of a node.

FIG. 23a, 23b. Examples of Pascal implementation of updating Position values during deleting of a node from Position Tree.

FIG. 24. Example of Pascal implementation of the delete node algorithm.

FIG. 25a, 25b. Example of deletion of node from Position Tree.

FIG. 26a, 26b. Example of deletion of node with updating Position values in the right sub-tree.

### DETAILED DESCRIPTION OF THE INVENTION

### Definitions

First of all, we have to define, which data we can use to construct the Position Tree. Besides the already mentioned character strings, one can use complex types of data, presenting the sets of elements, arranged in enumerated positions. Elements in different positions can be of different types, including the described one. Elements in different positions or even in all positions can also be of the same type.

The comparison of two of such complex values is defined as consequent comparison of the elements in corresponding positions, starting from the first position, until the first pair of differing elements is found. The result of comparing this pair determines the general result of comparison of complex values. In the case of equality of the elements in all the positions, the quantities are considered to be identical.

Now we can give a formal definition of the described data type.

Definition 1.

We shall say that data set C with elements {c₁, c₂, . . . cₙ} is of complex type if it fulfils the following conditions:

1. Each element c of C is an array of m sub-elements c[i], where position i:1≦i≦m;

2. There are standard comparison operations on sub-elements defined for each position i of C;

3. There is a comparison operation defined for all pairs of elements (cₓ, c_{y}) from C:

a. Let D be the set of all d, 1≦d≦m: cₓ[d]≠c_{y}[d];

b. If D is empty, then cₓ=c_{y},

c. If D is not empty and dₘᵢₙ is a minimal element of D:

i. if cₓ[dₘᵢₙ]>c_{y}[dₘᵢₙ], then cₓ>c_{y},

ii. if cₓ[dₘᵢₙ ]<c_{y}[dₘᵢₙ], then cₓ<c_{y}.

Note 1.

Sub-elements c

of elements c can be of different types for different positions. They also can be of the same type for some or even for all positions of C.

Note 2.

It is possible to expand the definition to include sets of arrays with different length by introducing an “empty” sub-element (fictitious or real) E for each position in C with the next properties:

1. E is equal to itself;

2. E is less than any other sub-element of the position.

Note 3.

The actual data type of the position value itself is not important for the methods of Position Tree.

Further on, speaking about complex type of data, we will intend the type, which will comply with the definition and the notes above.

Let us consider some examples of data set, which are suitable for constructing the Position Tree:

1. A set of n strings of the same length: S={s₁, s₂, . . . , sₙ}. In this simplest case, the sub-elements in all positions of the strings (symbols) are of the same type.

2. Sets of strings of different length. A special ‘zero’ symbol can be used for defining strings' ends.

3. A table of relational database. Elements c are the records of the given table, the positions define field numbers. We can also expand the notion of position, including in it the positions within the fields of complex types, if such are present.

In order to build the Position Tree, we need to save the comparison result and the position number of the first two differing elements of the compared keys. The signs: ‘+’ for ‘greater’, ‘−’ for ‘less’, ‘0’ for ‘equal’ can be used as the result of comparison.

Definition 2.

A binary search tree, built on data of complex type, will be called the Position Tree if it complies the following conditions:

1. There is an attribute defined for each node of the tree, except maybe the root node, that may take on two different values correspondent to greater and less results of comparison;

2. There is an attribute defined for each node of the tree, except maybe the root node, that may take on the values of the positions of sub-elements within the data.

Note 4.

The binary search tree may be not balanced, balanced or near-balanced. One can use AVL tree or Red-Black tree or any other binary search tree to build the Position Tree.

Definition 3.

The combination of the two additional attributes of the Position Tree, that represents a signed value of position of sub-elements of complex data, where the sign is ‘+’ for ‘greater’ and ‘−’ for ‘less’ comparison result, we will call Position. We will use the standard comparison operation of signed values for the new data type.

Let us add the new Position field according to Definition 3 into a binary tree node's structure. Let us define the new type of node as N={Key, LeftChild, RightChild, Position}, where Key is the value of complex type or the pointer to the value, LeftChild and RightChild are the corresponding pointers to the left and the right child nodes. We shall use the field Position in correspondence with the algorithms, given further.

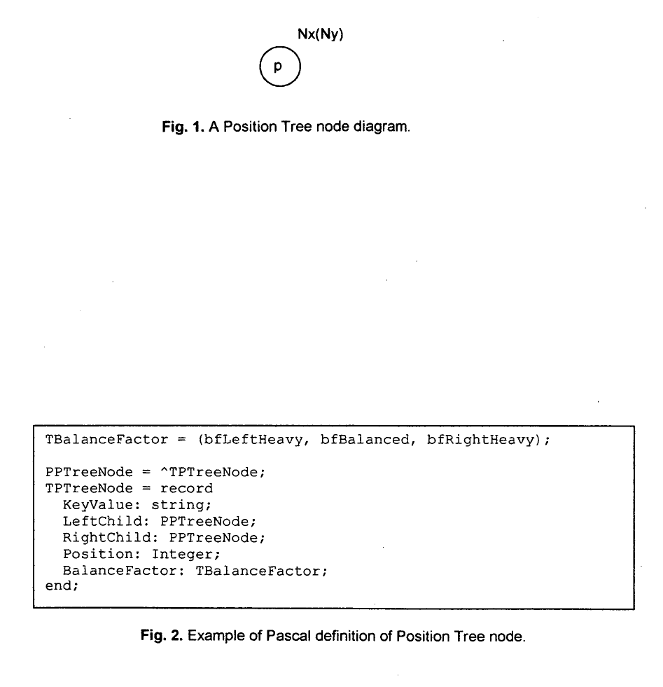

In order to present graphically a Position Tree node, it is expedient to use the diagram as shown in FIG. 1, where Nx is the definition of the given node, p is the Position value for the given node, and Ny is its Ancestor Node. The notion Ancestor Node will be defined in the next chapter.

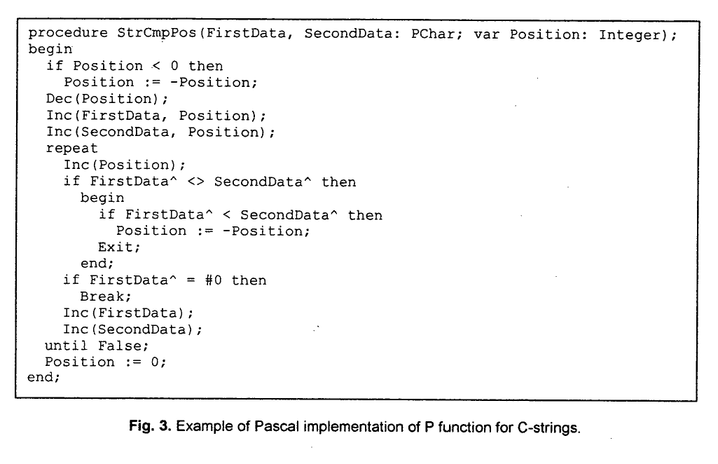

FIG. 2 shows an example of Pascal definition of Position Tree node. The key value KeyValue is a Pascal string. The BalanceFactor field can be used in AVL balancing algorithm.

Definition 4.

We shall call the Position Tree as being in the Initial State, if no operations were done in it, such as rotations or deleting, which would change relative positions of nodes.

Let us also introduce a new function we will use in search and insert algorithms.

Definition 5.

For any two elements cₓ, c_{y} from the set of complex type C (see Definition 1), let us define function P(cₓ, c_{y}, i), 1≦i≦m, in the following way:

1. Let D be the set of all d, i≦d≦m: cₓ[d]≠c_{y}[d];

2. If D is empty then P(cₓ, c_{y}, i)=0,

3. If D is not empty and dₘᵢₙ is a minimal element of D:

a. if cₓ[dₘᵢₙ]>c_{y}[dₘᵢₙ], then P(cₓ, c_{y}, i)=dₘᵢₙ;

b. if cₓ[dₘᵢₙ]<c_{y}[dₘᵢₙ], then P(c_{y}, c_{y}, i)=−dₘᵢₙ.

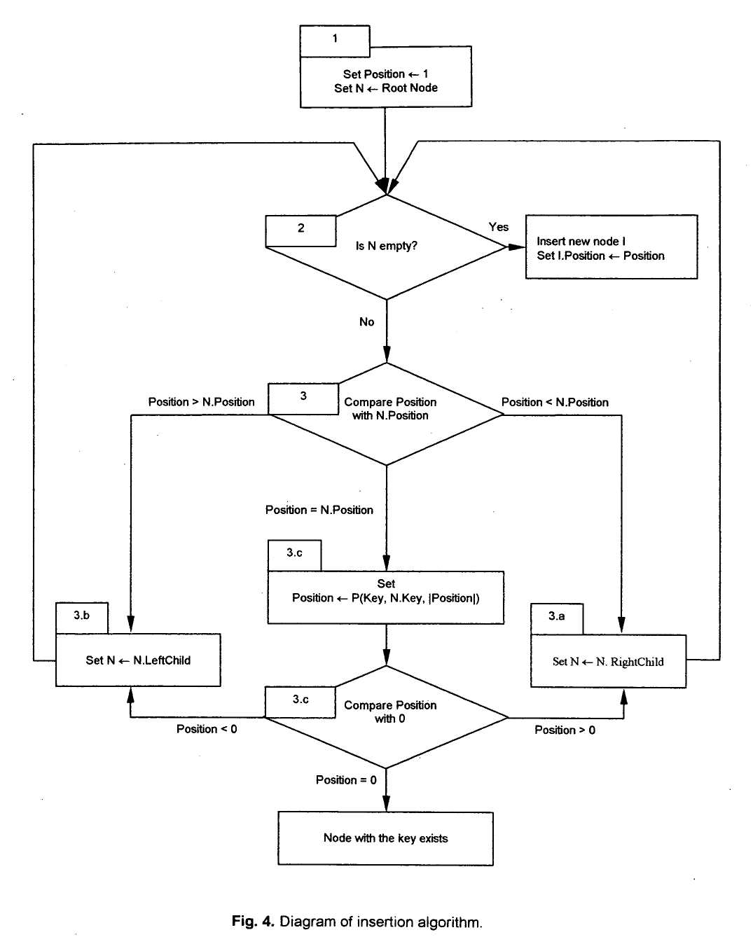

FIG. 3 gives us an example of such a function written on Pascal for C-strings.

Let us list some evident properties of the function P:

1. If P(cₓ,c_{y}, 1)=p:

a. p=0 [symbol] cₓ=c_{y};

b. p>0 [symbol] cₓ>cₓ>c_{y};

c. p<0 [symbol] cₓ<cₓ<c_{y};

2. If P(cₓ, c_{y}, 1)=p, then P(cₓ, c_{y}, q)=p for all q: 1≦q≦|p|;

3. If P(cₓ, c_{z}, 1)=p and P(c_{y}, c_{z}, 1)=q, where p and q have the same sign:

a. if p<q [symbol] cₓ>c_{y};

b. if p>q [symbol] cₓ<c_{y}.

Here and further on we denote absolute value of a value p as |p|. The absolute value of Position represents a position of sub-element regardless of the comparison sign attribute.

The last two properties 3a and 3b are the most useful for us. Using them, we can substitute the by-elements keys' comparison by a simple comparison of corresponding result values of P function. This makes the main idea of creation of Position Tree.

Let us consider the examples of usage of the introduced function on a set of three-character strings S={s₁, s₂, . . . , sₙ}. A usual procedure of by-character comparison, starting from the i-th character, is used as function P(sₓ, s_{y}, i):

1. P(“AAA”, “AAA”, 3)=0;

2. P(“ABC”, “AAA”, 2)=P(“ABC”, “AAA”, 1)=2;

3. P(“AAC”, “AAA”, 2)=P(“AAC”, “AAA”, 1)=3;

4. P(“AAC”, “AAA”, 2) >P(“ABC”, “AAA”, 2) >0 [symbol] “AAC”<“ABC”.

### Algorithm of Insertion

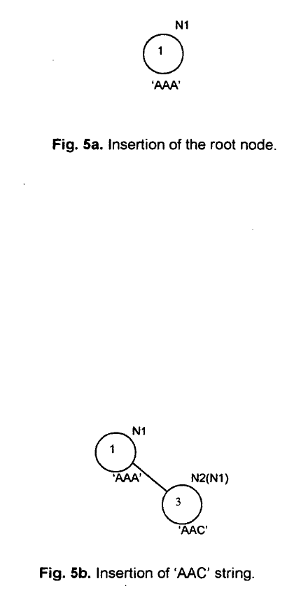

FIG. 4 shows the diagram of the insertion of a new node into the Position Tree. To insert a new node for the key value Key into the Position Tree, which is in the Initial State, it is necessary to perform the following steps (FIG. 4):

1. Set new variable Position←1. Set current node N to the root node of the tree.

2. If N is empty insert the new node I, set I.Positions Position←and exit

3. If N is not empty compare Position and N. Position:

a. If Position<N.Position set N←N.RightChild;

b. If Position>N.Position set N←N.LeftChild;

c. If Position=N.Position set Position←P(Key, N.Key, |N.Position|) and do:

i. If Position=0 do “on equal values” and exit;

ii. If Position>0 set N←N. RightChild;

iii. If Position<0 set N←N. LeftChild.

4. Continue from step 2.

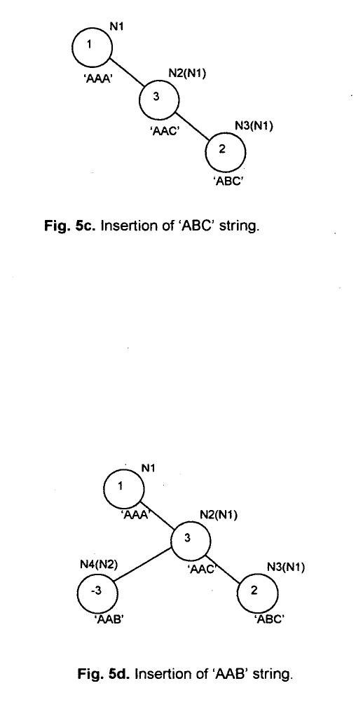

FIGS. 5a-5d illustrate the insertion operation on a set of three-character strings. We have considered the creation of Position Tree with consecutive insertion of strings ‘AAA’, ‘AAC’, ‘ABC’ and ‘AAB’ by using the comparison rules, taken from the example above.

FIG. 5a shows insertion of the root node for the key value ‘AAA’. The Position field of the new node N1 is assigned the initial value 1.

FIG. 5b shows insertion of the second node for the key value ‘AAC’. The following steps were performed:

1. The initial value of Position field of the node to be inserted equals to the value of Position field of the root node N1. We perform comparison of nodes' keys, starting from the first character. ‘AAC’ is greater than ‘AAA’ in the third character.

2. The new node N2 is placed to the right of the root node with the current value of the Position field equal to 3.

FIG. 5c shows insertion of the third node for the key value ‘ABC’. The following steps were performed:

1. Comparison the new key value with the value of the root node N1. ‘ABC’ is greater than ‘AAA’ in the second character.

2. We save the current value of Position, equal to 2, and proceed to the second node N2.

3. Comparison the obtained Position value with the value of Position field of the second node.

4. The current Position value (equal to 2) is less than Position field of the second node (equal to 3), thus the third node N3 is to be placed to the right of the second, and no comparison of their keys is made.

FIG. 5d shows insertion of the fourth node for the key value ‘AAB’. The following steps were performed:

1. Comparison the new key value with the value of the root node N1. ‘AAB’ is greater than ‘AAA’ in the third character.

2. As the obtained value 3 is equal to the value of the Position field of the second node N2, it is necessary to perform comparison of the key to be inserted with the key of the second node, but starting from the third character.

3. ‘AAB’ is less than ‘AAC’ in the third character. Consequently the fourth node N4 is placed to the left of the second with the value of Position field equal to −3.

Using the given algorithm of insertion, let us introduce a number of new notions, which will be useful for us in future.

Definition 6.

The Position Tree node N shell be called the Ancestor Node for some certain node I from the same tree if the tree is in Initial Sate and the result of comparison P(I.Key, N.Key, . . . ) during inserting of node I is saved in the Position field of node I.

In other words, Ancestor Node is the last node where key comparison with the inserting node has occurred.

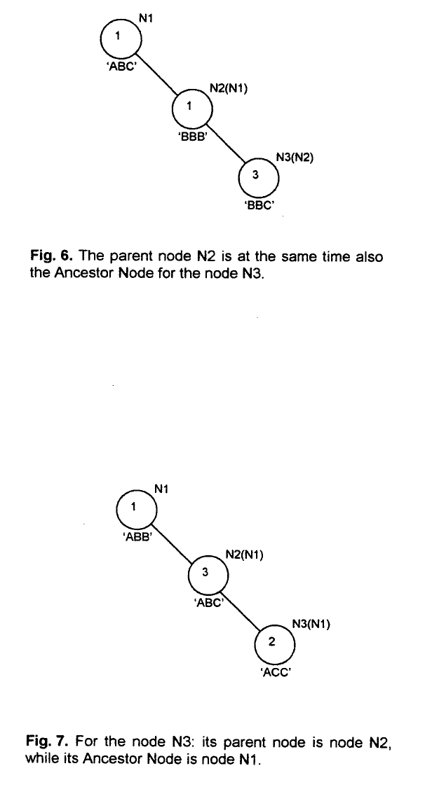

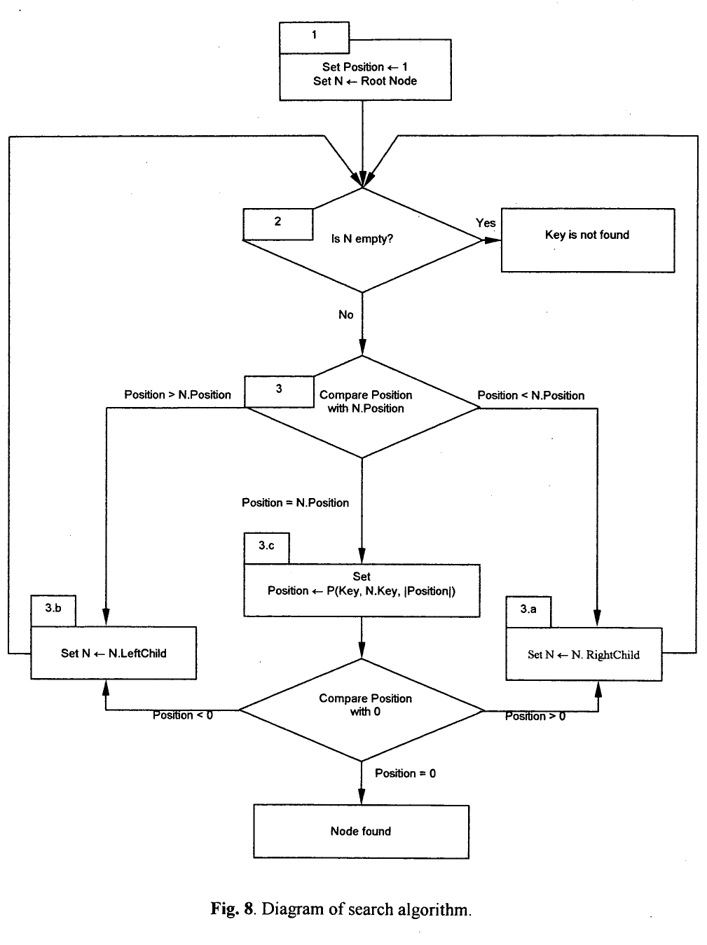

FIGS. 6 and 7 show that the parent node can either be, or not be the Ancestor Node for the given Position Tree node. The parent node N2 is at the same time also the Ancestor Node for the node N3 in FIG. 6. For the node N3 in FIG. 7: its parent node is node N2, while its Ancestor Node is node N1.

Definition 7.

The chain of nodes of Position Tree, beginning from a certain node, in which each subsequent node is the Ancestor Node for the previous one, will be called the Ancestry Chain for the given node.

Search Algorithm

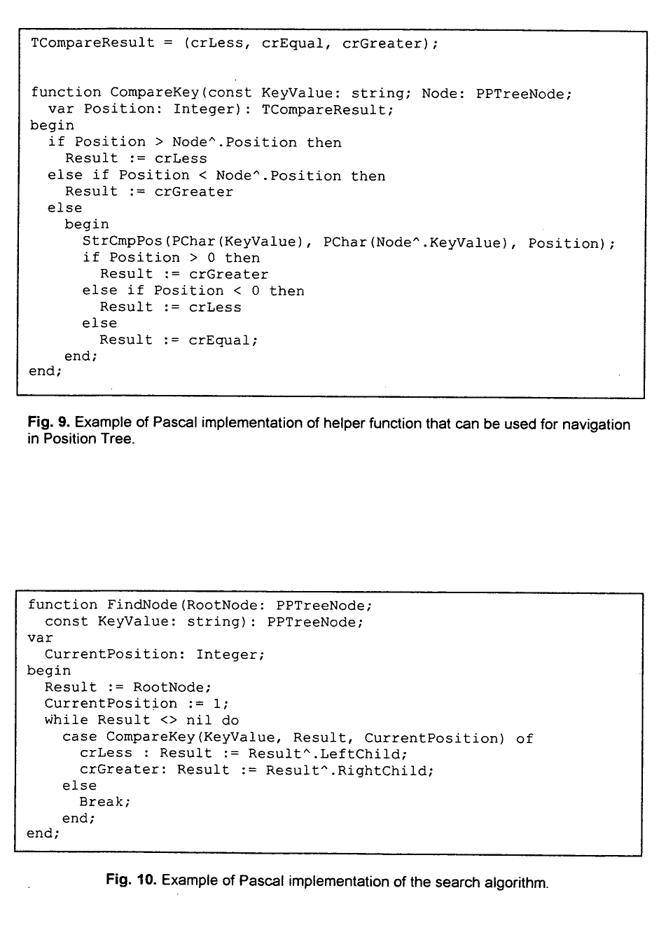

Search algorithm repeats the algorithm of insertion in many respects. The same logic is used in progressing from node to node. In order to find the key value Key in Position Tree, which is in the Initial State, the following steps are to be followed (FIG. 8):

1. Set new variable Position<1. Set node pointer N to the root node.

2. If N is empty [symbol] search failed, exit.

3. If N is not empty compare Position and N. Position:

a. If Position<N.Position set N←N.RightChild;

b. If Position>N. Position set N←N.LeftChild;

c. If Position=N.Position set Position←P(Key, N.Key, |Position|) and do:

i. If Position=0 [symbol] N. Key=Key, node found, exit,

ii. If Position>0 set N←N. RightChild;

iii. If Position<0 set N←N. LeftChild.

4. Continue from step 2.

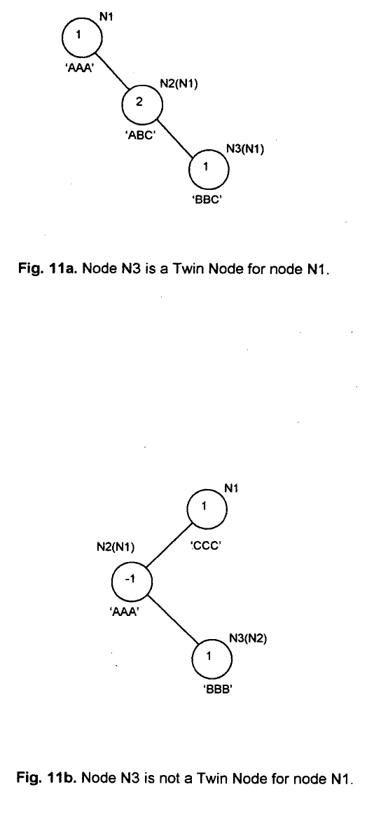

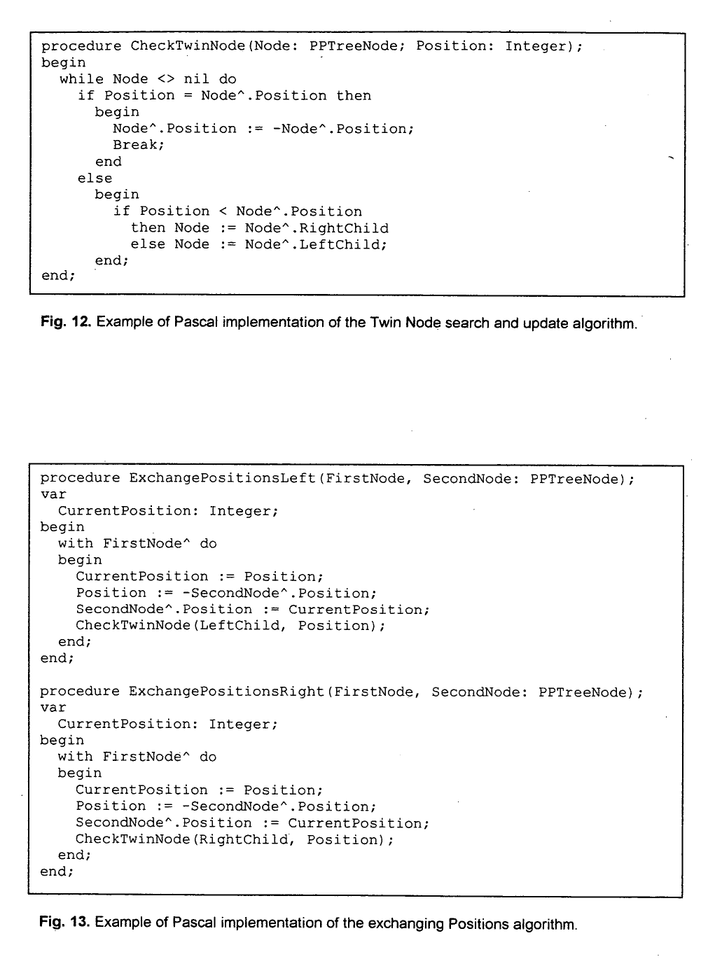

FIG. 9 shows an example of Pascal implementation of step 3 of the algorithm as a separate function. The utilization of the function is illustrated in FIG. 10, where we can see the full search algorithm for Pascal strings. The search starts from the root node RootNode and returns the node with KeyValue key value if such a node exists.

### Position Tree Properties

In this chapter let us examine some characteristics of Position Tree that is in Initial State.

We have included in the first group those properties that affect the speed of insertion and search operations. We denote the current value of the Position variable from corresponding algorithms as p and make the following obvious statements:

1. While comparing two keys during insertion or search it is not necessary to compare key elements up to the elements in positions |p|, |p|≧1.

2. |p| value does not decrease while progressing from one tree node to another.

3. If the value of the Position field of the current node is not equal to p, comparison of keys is not required at all.

The above-noted properties of the Position Tree show that it is possible to accelerate the search and insertion of keys by decreasing the number of compared key elements or by replacing the comparison of keys with the faster comparison of integer Position fields.

Now let us examine the properties related to the balancing and deleting of nodes from the Position Tree. While during insertion and search the nodes within the tree are not repositioned, this is not the case with the balancing and deletion procedures. In addition, any repositioning of nodes changes the order of key comparison for further operations and hence disturbs all logic of the using of Position fields values.

It appears that in order to continue using the Position Tree with balancing and removal procedures there is a way of changing the values of Position fields for a small number of nodes in such manner that the resulting structure will appear as if it were formed using only node insertion without repositioning of the same. We will refer to such changes as the restoring of the Initial State of the given Position Tree.

In order to facilitate the understanding of the algorithms of the restoring of the Initial State presented below, let us examine some features of the Position fields of the Position Tree nodes:

1. For parent node PN and its child nodes RC=PN.RightChild and LC=PN.LeftChild:

a. if RC.Position≧PN.Position [symbol] PN is Ancestor Node for RC;

b. if LC.Position≦PN.Position [symbol] PN is Ancestor Node for LC;

2. Denoting the Position field's value of node N as p:

a. if p>0 [symbol] |LS.Position|≧|p| for all nodes LS from the left subtree of N;

b. if p<0 [symbol] |RS.Position|≧|p| for all nodes RS from the right subtree of N.

Another important feature of the Position Tree requires some preliminary definitions.

Definition 8.

Let us say that the node of the binary tree is located between two other nodes of this tree—M and N, if it belongs to the chain of nodes connecting nodes M and N.

Definition 9.

We will call Position Tree node M belonging to one of the sub-trees of node N the Twin Node of node N if the following conditions are met:

1. M.Position=N.Position;

2. There are no such nodes X between N and M that |X.Position|=|N.Position|.

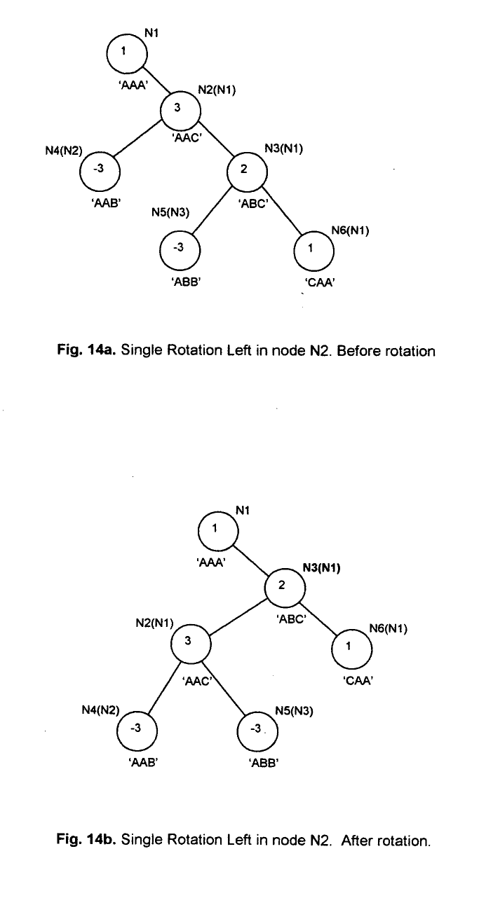

FIGS. 11a and 11b show examples of using the definition of the Twin Node. Node N3 is a Twin Node for node N1 in FIG. 11a, but it is not a Twin Node for node N1 in FIG. 11b because of the node N2 with the same absolute value of Position between N1 and N3.

It is easily verifiable that the following property is true for Twin Nodes:

1. For all nodes N with N.Position>0: there is no Twin Node for N in the left sub-tree of N;

2. For all nodes N with N.Position<0: there is no Twin Node for N in the right sub-tree of N.

Later on we will need Twin Node search algorithm. To find the Twin Node T for node N in one of the left or right sub-tree of node N we will use the function FindTwinNode(CN, Position), where CN is one of N.RightChild or N.LeftChild and Position is N.Position:

1. Set T←CN;

2. If T is empty= [symbol] search failed, exit;

3. If T is not empty then do compare Position and T Position:

3.1. If Position=T.Position [symbol] node found, exit,

3.2. If Position>T.Position set T←T.LeftChild;

3.3. If Position<T.Position set T←T.RightChild;

4. Continue from step 2.

Another algorithm that is used in the transformations related to the restoring of Initial State of Position Tree determines the rules for the repositioning of Position fields values. Let us define ExchangePositions(FirstNode, SecondNode) procedure for nodes FirstNode and SecondNode as:

1. Set new parameter Position←FirstNode.Position;

2. Set FirstNode.Position←−SecondNode.Position;

3. Set SecondNode.Position←Position.

Note the asymmetry of this procedure: one of the nodes receives Position field value from another with the opposite sign.

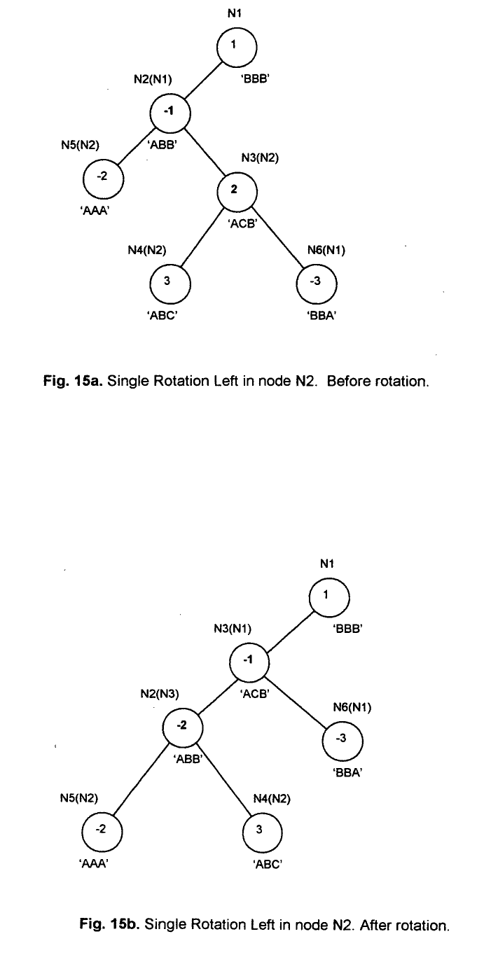

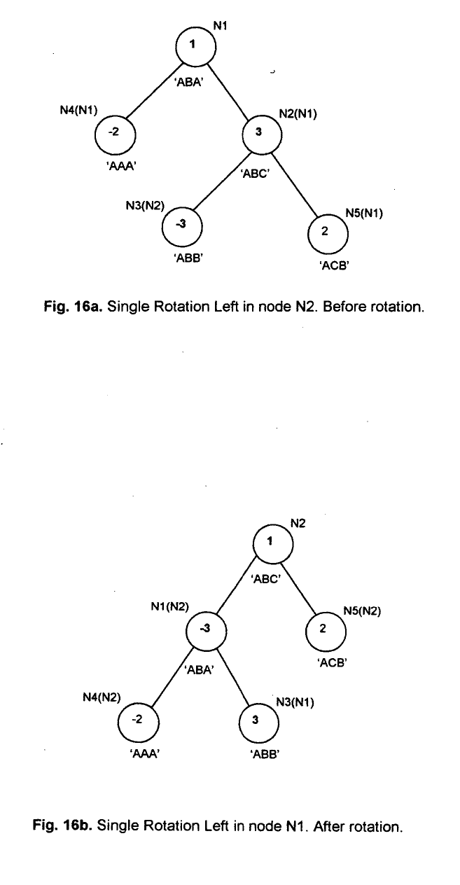

Examples of the implementation of the methods are shown in FIGS. 12 and 13.

### Rotations

As we noted above, node rotations performed for the balancing of the binary tree disturb the sequence of keys comparison, which makes it impossible to use insertion and search procedures in the Position Tree. The purpose of the algorithms presented in this chapter is to restore the Initial State of Position Tree when balancing rotations are used.

Before writing proper algorithms let us examine possible variants of changes in Position fields using Single Rotation Left as an example.

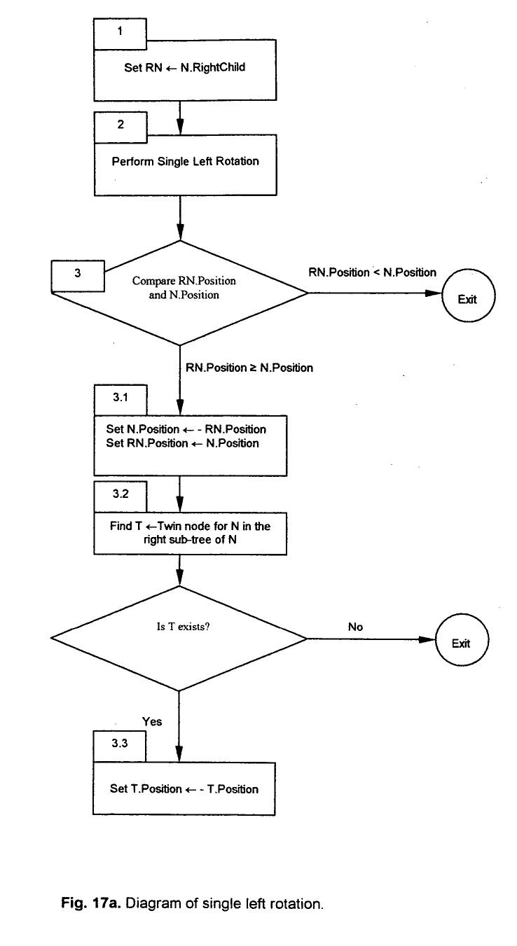

FIGS. 14a and 14b show the simplest case of Single Rotation Left in node N2. The value of the Position field of node N2 (equal to 3) is greater than the value of the Position field of node N3 (equal to 2) in FIG. 14a. In this case no changes in the Position fields are required (FIG. 14b).

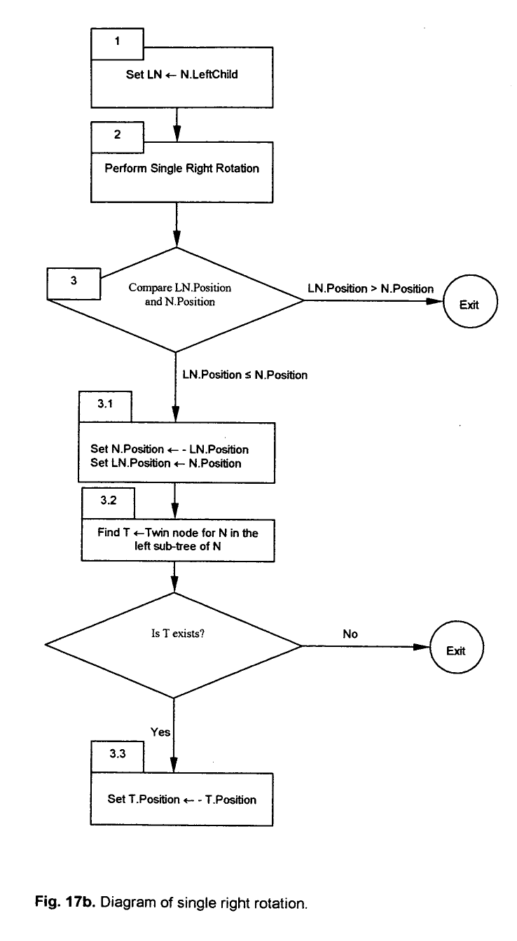

FIGS. 15a and 15b show an example of Single Rotation Left in node N2 with exchanging Position values for the nodes. The value of the Position field of node N2 (equal to −1) is less than the value of the Position field of node N3 (equal to 2) in FIG. 15a. In this case the repositioning of the Position values of nodes N2 and N3 is required using the ExchangePositions(N2, N3) algorithm (FIG. 15b).

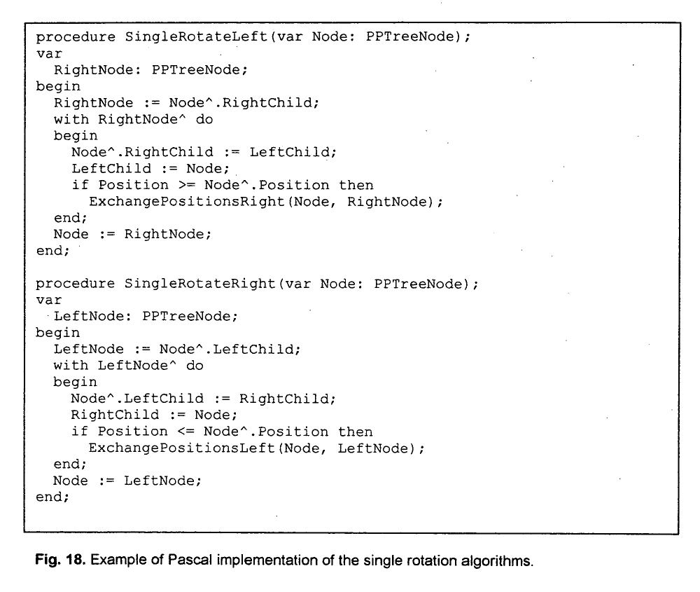

FIGS. 16a and 16b show an example of Single Rotation Left in node N1 with updating Twin Node sign. Changes in the values of Position fields for nodes N1 and N2 (FIG. 16a) lead to the violation of the Twin Node rule. After the rotation and the application of the procedure ExchangePositions(N1, N2) we find that node N3 located in the right sub-tree of node N1 has the same value of the Position field as node N1 (equal to −3 before rotation). In this case it is necessary to change the sign of the Position field of node N3 to the opposite one (FIG. 16b).

Similar examples can be easily constructed for Single Rotation Right. Double rotations may be presented as a sequence of single rotations and do not need to be examined separately.

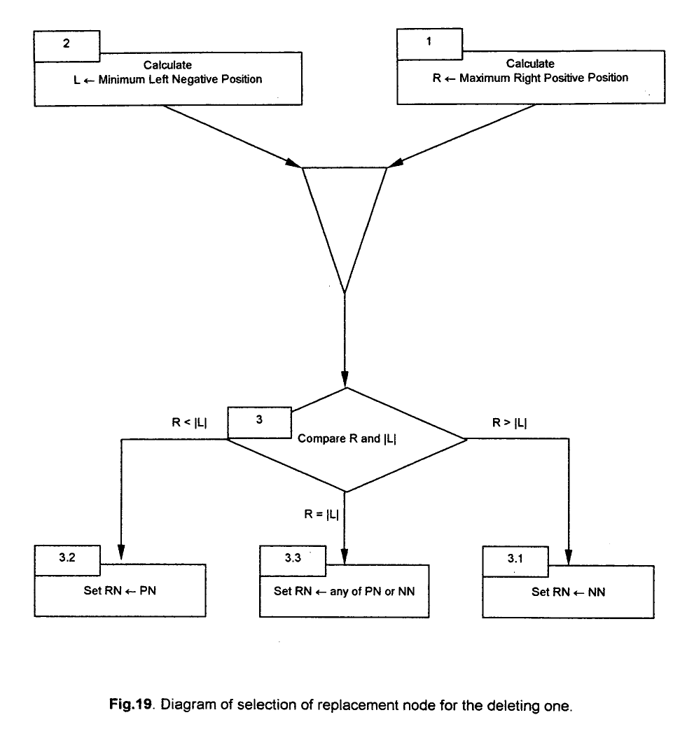

This is the algorithm of Single Rotation Left in node N with the renewal of the Initial State of Position Tree (FIG. 17a):

1. Set new pointer RN←N.RightChild;

2. Do standard Single Rotation Left procedure in node N;

3. If RN. Position≧N. Position do:

3.1. Do ExchangePositions(N, RN);

3.2. Find T←FindTwinNode(N.RightChild, N.Position);

3.3. If T is not empty set T.Position←−T.Position.

This algorithm can be written for Single Rotation Right as follows (FIG. 17b):

1. Set new pointer LN←N.LeftChild;

2. Do standard Single Rotation Right procedure in node N;

3. If LN. Position≦N.Position do:

3.1. Do ExchangePositions(N, LN);

3.2. Find T FindTwinNode(N.LeftChild, N.Position);

3.3. If T is not empty set T.Position←−T.Position.

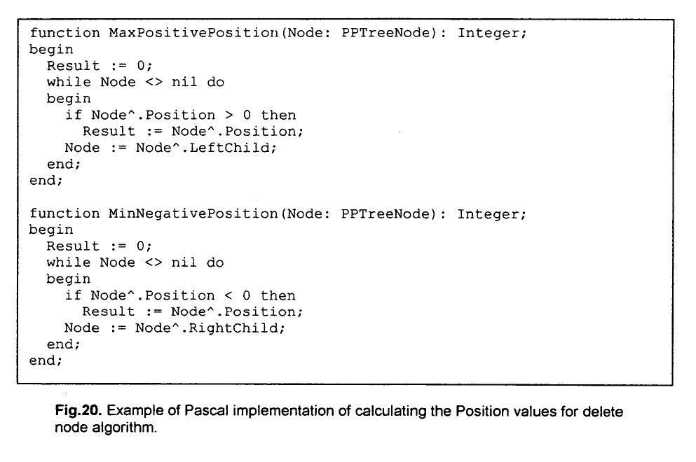

Examples of Pascal implementation of the methods are shown in FIG. 18.

### Deletion Algorithm

The deletion of a node from the Position Tree using the standard algorithm for the binary tree may disturb the Initial State of the given Position Tree too. In this chapter we shall examine transformations that are necessary for the restoring of Initial State in the course of the deletion.

Let us denote the node to be deleted as N. At first let us examine the most complete case when both sub-trees of N are not empty and the sub-trees of nodes N.LeftChild and N.RightChild are not empty either. Let us denote the preceding and the next nodes for node N as PN and NN respectively (please remember that the preceding node is the rightmost node from Node N.LeftChild, and the next node is the leftmost one from N.RightChild).

The known algorithm for the deletion of a node from the binary tree involves moving any of PN or NN to the location of the deleted node N. We will denote the node selected for the replacement as RN. It turns out that for Position Tree it is important which node is used for the replacement—PN or NN.

Indeed, if |P(N.Key, RN.Key, 1)| is maximum on {PN, NN}, the replacement can not affect the nodes from the opposite sub-tree of node N because the difference between N and RN keys manifests in a more remote position than the one between the key of node N and any node from the opposite sub-tree.

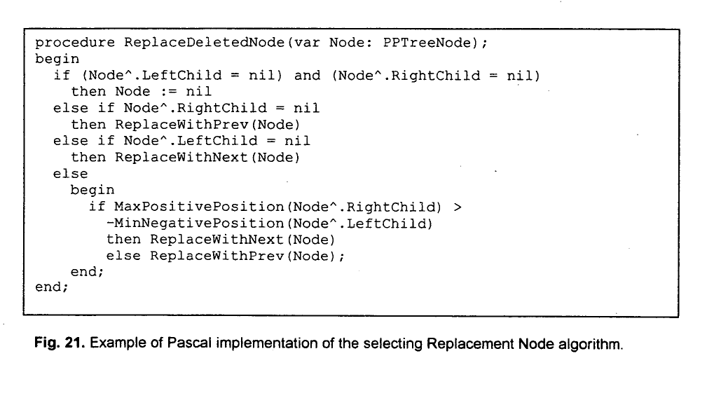

To choose the node between PN and NN with the above condition, we can use the function SelectReplacementNode(N) (FIG. 19):

1. Calculate MaximumRightPositivePosition value as maximum Position on nodes R, where R is set of all those nodes between N and NN and NN itself, where Position>0. Set MaximumRightPositivePosition=0 if R is empty;

2. Calculate MinimumLeftNegativePosition value as minimum Position on nodes L, where L is set of all those nodes between N and PN and PN itself, where Position<0. Set MinimumLeftNegativePosition=0 if L is empty;

3. Compare MaximumRightPositivePosition and |MinimumLeftNegativePosition|:

3.1. If

MaximumRightPositivePosition>|MinimumLeftNegativePosition|, then set RN←NN;

3.2. If

MaximumRightPositivePosition<|MinimumLeftNegativePosition|, then set RN←PN;

3.3. If

MaximumRightPositivePosition=|MinimumLeftNegativePosition|, then set RN to any of PN or NN;

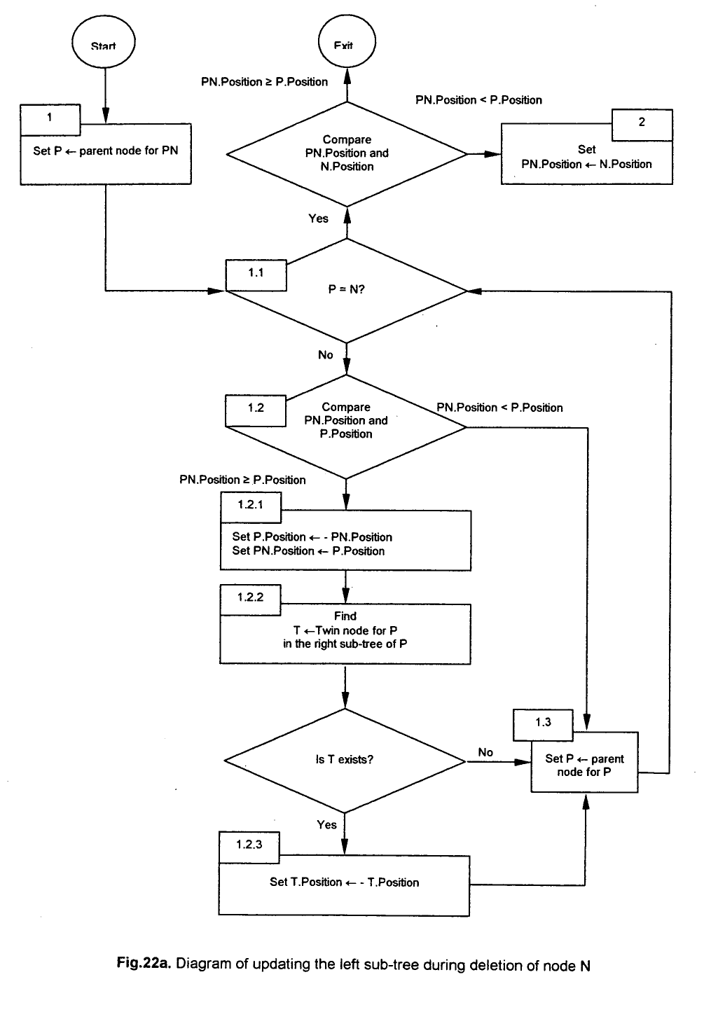

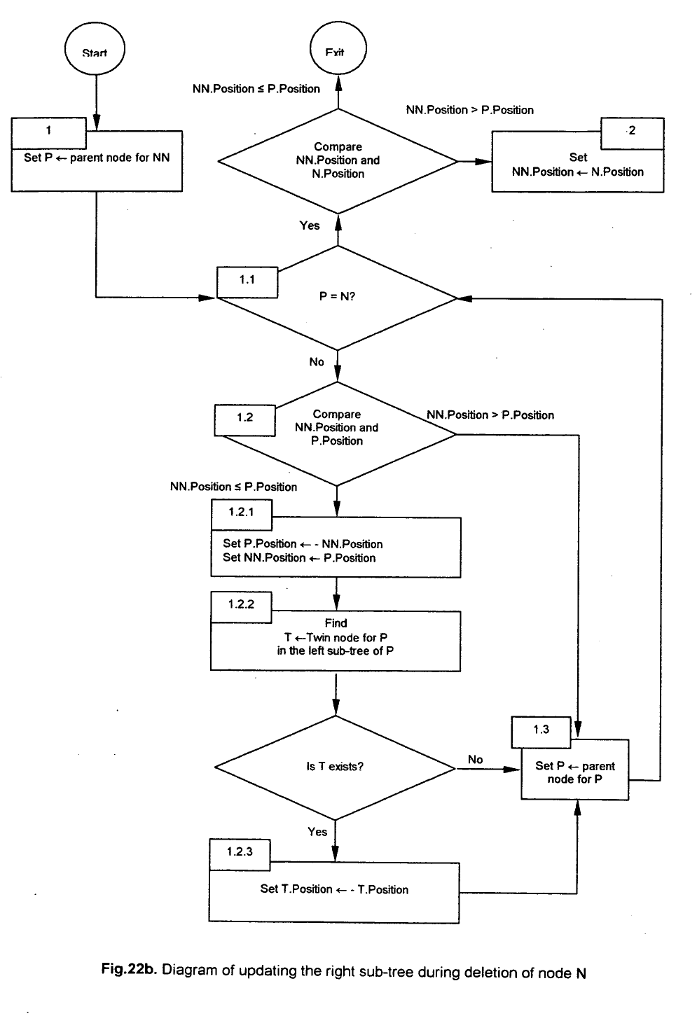

Examples of Pascal code for calculating the MaximumRightPositivePosition and MinimumLeftNegativePosition values are shown in FIG. 20. FIG. 21 shows an example of the full implementation of selection replacement node algorithm.

The second characteristic of the deletion is that the moving node RN to the place of node N disturbs the sequence of the comparison of keys for the nodes belonging to Ancestry Chain of RN and located between N and RN. Therefore, we have to update Position field values for all the nodes.

Apart from that it is necessary to verify the Twin Node rule for every change in the value of Position fields as we did in the rotation algorithms.

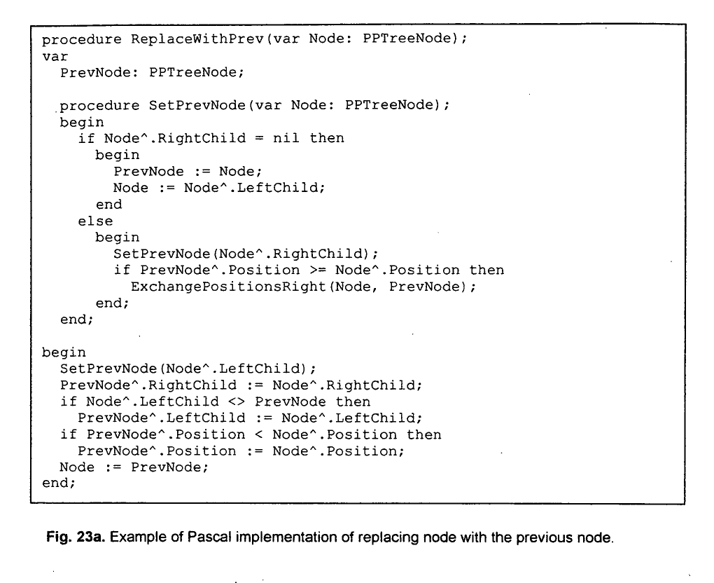

Let us write the procedure UpdateLeftSubtree(N, PN) for RN=PN (FIG. 22a):

1. Set new pointer P←parent node for PN;

2. Do following steps:

2.1. If P=N, then continue from step 3;

2.2. If PN. Position≧P. Position, then do:

2.2.1. Do ExchangePositions(P, PN);

2.2.2. Find T←FindTwinNode(P.RightChild, P.Position);

2.2.3. If T is not empty, then set T.Position←−T.Position;

2.3. Set P←parent node for P, continue from step 2.1;

3. If PN.Position<N.Position, then set PN.Position←N.Position.

Similar procedure UpdateRightSubtree(N, NN) for RN=NN (FIG. 22b):

1. Set new pointer P←parent node for NN;

2. Do following steps:

2.1. If P=N, then continue from step 3;

2.2. If NN.Position≦P.Position, then do:

2.2.1. Do ExchangePositions(P, NN);

2.2.2. Find T←FindTwinNode(P.LeftChild, P.Position);

2.2.3. If T is not empty, then set T.Position←−T.Position;

2.3. Set P←parent node for P, continue from step 2.1;

3. If NN.Position>N.Position, then set NN.Position←N.Position.

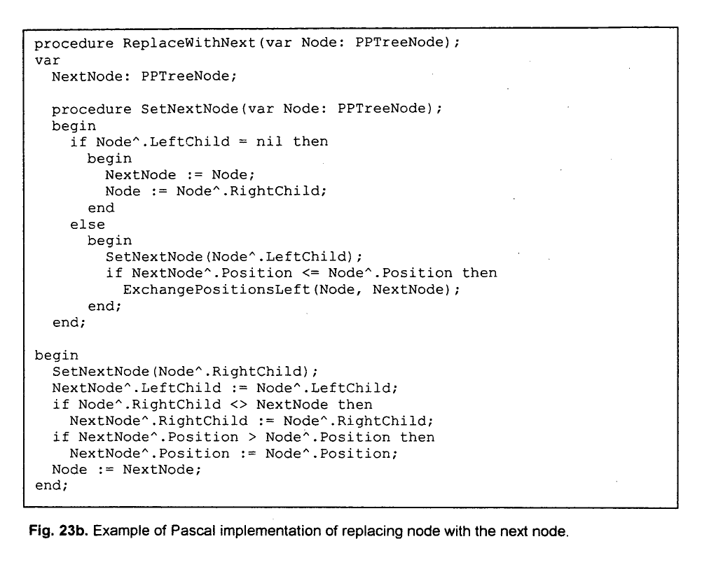

FIGS. 23a and 23b show examples of Pascal implementation of the methods.

After these explanations it can be easily understood how the complete algorithm of deletion of node N from Position Tree with the restoring of Initial State of the Position Tree:

1. If both subtrees of N are empty, then continue from step 5 with empty RN;

2. If one of subtrees of N is empty, then set RN to the node left and continue from step 4;

3. Set RN←SelectReplacementNode(N);

4. If RN is PN, then do UpdateLeftSubtree(N, RN), else do UpdateRightSubtree(N, RN);

5. Do standard delete operation for node N using node RN for replacement if RN is not empty.

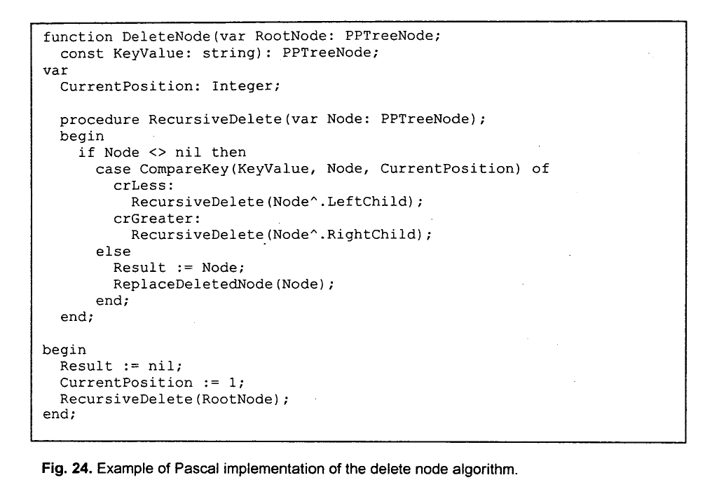

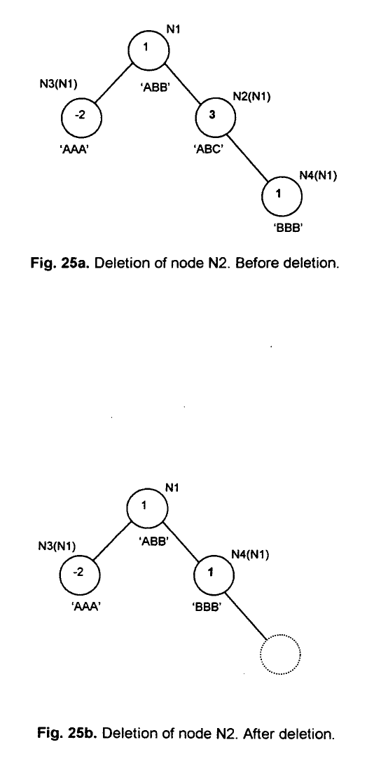

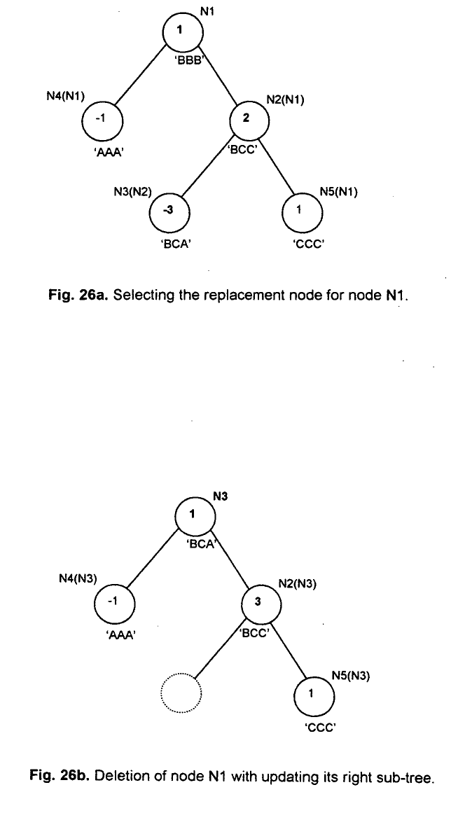

An example of delete algorithm implementation is shown in FIG. 24. FIGS. 25 and 26 illustrate various cases of the deletion of a node from Position Tree.

The value of Position field of the replacement node N4 (equal to 1) is less than the value of the Position field of the deleted node N2 (equal to 3) in FIG. 25a. Hence node N4 retains the value of its Position field when being moved to the location of node N2 (FIG. 25b).

FIG. 26a illustrates selecting the replacement node for node N1. The following steps where performed:

1. Calculating maximum right positive Position value (equal 2 in node N2).

2. Calculating minimum left negative Position value (equal −1 in node N4).

3. Maximum right positive Position is greater then the absolute value of minimum left negative Position, therefore the replacement node for N1 is next node (N3).

FIG. 26b shows deleting of node N1 from the tree of the FIG. 26a with updating its right sub-tree. The following steps where performed:

1. Selecting replacement node as shown in FIG. 26a.

2. Finding and updating Ancestry Chain nodes. Node N2 belonging to Ancestry Chain of node N3 assumes the Position value of node N3 with the opposite sign.

3. Assigning the Position value for the replacement node. Node N3 receives the Position field value of the deleted node because the current value of its Position field (equal to 2 after ExchangePositions(N2, N3)) is greater than the Position field value of node N1 (equal to 1).

What is claimed is:

1. A new data structure, comprising:
a. A binary search tree built on a set of complex data or pointers to complex data, wherein complex data represent a series of elements in indexed positions;
b. A sign attribute defined for each node of the tree, except maybe the root node, wherein said sign attribute means an attribute that may take on two different values: positive and negative, wherein said positive means correspondent to greater and negative means correspondent to less results of comparison of complex data;
c. A position attribute defined for each node of the tree, except maybe the root node, wherein said position attribute means an attribute that may take on the values of the index of elements within the complex data.

2. The new data structure as defined in claim 1, wherein the binary search tree is a balanced binary search tree or near-balanced binary search tree.

3. The new data structure as defined in claim 1, wherein the binary search tree is an AVL tree or red-black tree.

4. A method of searching a key value in the data structure defined in claim 1, comprising the steps of:
a. Obtaining the current sign and position values by comparing the target key value with the key value of the root node of the tree; proceeding to the next step, wherein the root node is treated as the current node;
b. Determining if the target key value is found based on the result of the previous step and exiting the method if the key value is found;
c. Selecting the next node between the child nodes of the current node based on the current sign value, and proceeding, if the next node exists, to the next step, wherein the next node is treated as the current node,
d. Comparing the current sign and position values with the values of the sign and the position attributes of the current node; proceeding to step (f) if the values are equal;
e. Selecting the next node between the child nodes of the current node based on the result of comparison in the previous step and proceeding, if the next node exists, to the previous step, wherein the next node is treated as the current node if the values are not equal;
f. Obtaining the new sign and position values by comparing the target key value with the key value of the current node of the tree starting from the elements in the current position and proceeding to step (b), wherein the new sign and position values are treated as the current values;

5. A method of updating of the values of the sign and the position attributes of nodes of the data structure defined in claim 1, before, during or after single rotation of the nodes, comprising the steps of:
a. Determining the necessity of the updating by comparing the values of the sign and the position attributes of the node to rotate in and the node to move into the place of the first one;
b. Updating the values of the sign and position attributes of the node to rotate in and the node to move into the place of the first one when the second node receives the values of the sign and the position attributes of the first one and the first node receives the value of the position attribute and the opposite value of the sign attribute of the second one;
c. Determining the existence and selecting, if it exists, the node in one of the sub-trees of one of the two nodes from the previous step with the same value of the position attribute;
d. Changing the value of the sign attribute of the node found in the previous step to the opposite if such a node exist.

6. A method of inserting of a new node for a key value into the data structure defined in claim 1, comprising the steps of:
a. Finding the place to insert the new node according to the method of claim 4 for the new key value;
b. Inserting the new node into the tree and setting the sign and the position values of the new node to the current values from the previous step;
c. Performing rotations of nodes of the tree according to the balancing criteria of the tree;
d. Updating the sign and the position attributes of the tree before, during or after each single rotation according to the method of claim 5.

7. A method of indexing of a set of data that represent a series of elements in indexed positions, comprising:
a. Inserting new nodes for the members of the data set into the data structure according to the method of claim 6;
b. Using the data structure from the previous step as indexing structure for the data set.

8. A method of sorting of a set of data that represent a series of elements in indexed positions, comprising the steps of:
a. Inserting new nodes for the members of the data set into the data structure according to the method of claim 6;
b. Passing the binary search tree to get the result set.

9. A method of selecting a replacement node for the deleting one between the previous and the next node to the deleting one in the data structure defined in claim 1, comprising the steps of:
a. Calculating the maximal value of the position attribute on all nodes with positive value of the sign attribute between the deleting node and the next to the deleting one including the next node itself;
b. Calculating the maximal value of the position attribute on all nodes with negative value of the sign attribute between the deleting one and the previous to the deleting one including the previous node itself;
c. Comparing the values calculated in the previous steps and selecting the next node as a replacement node if the value calculated in step (a) is greater, or selecting the previous node if the value calculated in step (b) is greater, or selecting one of the nodes if the values are equal.

10. A method of updating of the values of the sign and position attributes of nodes of the data structure defined in claim 1, before, during or after deletion of the node, comprising the steps of:
a. Determining the existence and selecting nodes to update between the deleting and the replacement node by comparing the values of the sign and position attributes of the nodes;
b. Exchanging the values of the nodes selected in step (a) when one of the nodes receives the values of the sign and position attributes of the second one and the second one receives the value of the position attribute and the opposite value of the sign attribute of the first one;
c. Determining the existence and selecting, if it exists, the node with the same value of the position attribute in one of the sub-trees for each node selected in step (a);
d. Changing the value of the sign attribute of the nodes found in the previous step to the opposite;
e. Determining the new values of the sign and position attributes for the replacement node by comparing the values of the attributes for the nodes selected in step (a) and the replacement node and the deleting and the replacement node themselves.

11. A computer-readable medium having stored thereon computer-executable instructions for performing the method of claim 5.

12. A computer-readable medium having stored thereon computer-executable instructions for performing the method of claim 9.

13. A computer-readable medium having stored thereon computer-executable instructions for performing the method of claim 10.

14. Apparatus configured to perform the method of claim 5.

15. Apparatus configured to perform the method of claim 9.

16. Apparatus configured to perform the method of claim 10.
